(19) United States
(12) Patent Application Publication
(10) Pub. No.: US 2011/0267471 A1
(43) Pub. Date: Nov. 3, 2011

(54) SECURITY MONITORING SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/850,647

(22) Filed: Aug. 5, 2010

(30) Foreign Application Priority Data
Apr. 28, 2010 (TW) 99113415

(51) Int. Cl. H04N 7/18

(52) U.S. Cl. 348/159; 348/E07.086

(57) ABSTRACT

A security monitoring system includes a display, a power source, a main camera, a number of sub-cameras, a processor, and a storage unit. The main camera is connected to the power source though a power cable and connected to the display through a data cable. Each sub-camera includes a power unit, a network unit, and a capturing unit. The storage unit includes a detecting module and a camera selecting module. The detecting module stores a first instruction to be executed by the processor, thereby the processor determines whether the main camera is malfunctioning. The camera selecting module stores a second instruction to be executed by the processor, thereby the processor initiates the operation of the sub-cameras if the main camera is malfunctioning.

### BACKGROUND

1. Technical Field

The present disclosure relates to a security monitoring system and a security monitoring method.

2. Description of Related Art

A conventional security camera monitors a limited location. When a person stands outside of the monitoring field of view of the conventional security camera or disconnects the power and/or data cable or destroys the lens of the camera, the camera cannot capture the images of the person or monitored field of view.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic block diagram of an exemplary embodiment of a security monitoring system.

FIG. 2 is an isometric view of the security monitoring system of FIG. 1.

FIG. 3 is a flow chart of an exemplary embodiment of a security monitoring method.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

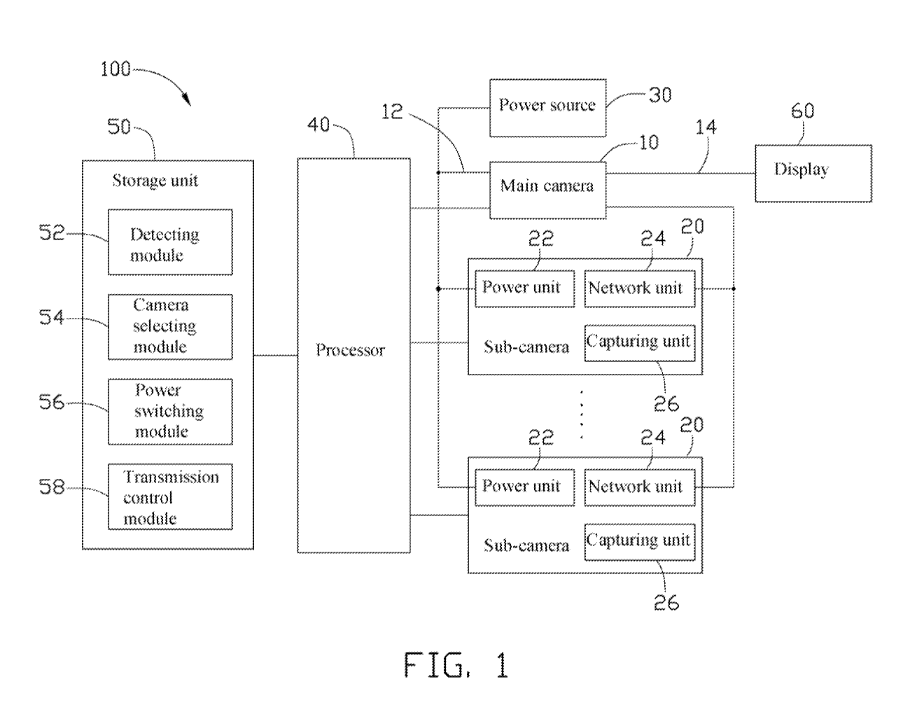

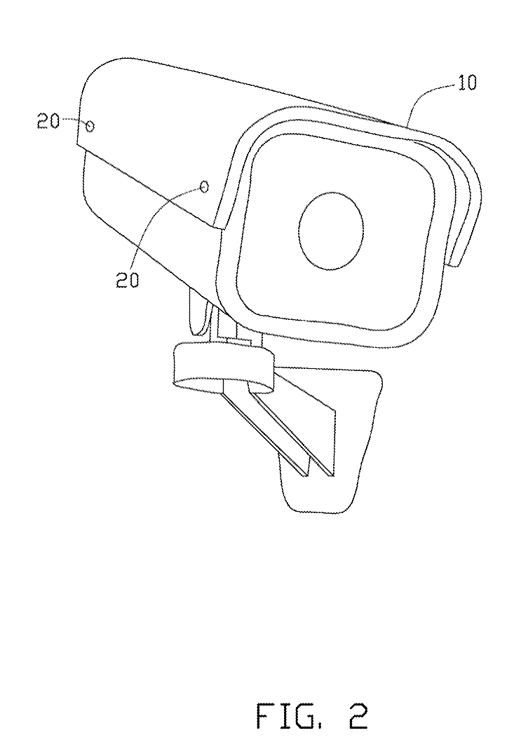

Referring to FIGS. 1 and 2, an exemplary embodiment of a security monitoring system 100 includes a main camera 10, a plurality of sub-cameras 20, a power source 30, a processor 40, a storage unit 50, and a display 60. The security monitoring system 100 can monitor a location by the sub-cameras 20 when the main camera 10 is malfunctioning.

The main camera 10 is connected to the power source 30 through a power cable 12. The main camera 10 is connected to the display 60 through a data cable 14. The power source 30 supplies power to the main camera 10. The display 60 displays images captured by the main camera 10.

Referring to FIG. 2, the sub-cameras 20 are wireless hidden cameras. The sub-cameras 20 are set on different positions of the main camera 10, such as the left, right and bottom sides of the main camera 10.

Each sub-camera 20 includes a power unit 22, a network unit 24, and a capturing unit 26. The capturing unit 26 is used to capture images. The network unit 24 is used to transmit the images captured by the capturing unit 26 to the display 60. The power unit 22 of each sub-camera 20 supplies power to the network unit 24 and the capturing unit 26. In one embodiment, the power unit 22 is a rechargeable battery.

The main camera 10 is connected to one or more network units 24. The network units 24 of the sub-cameras 20 transmit the images captured by the main camera 10 to the display 60 when the data cable 14 of the main camera 10 is disconnected or fails to transmit data.

The power source 30 is connected to the power unit 22 of each sub-camera 20. The power unit 22 of each sub-camera 20 is also connected to the main camera 10. The power source 30 charges the power unit 22 of each sub-camera 20. The power units 22 of the sub-cameras 20 also supply power to the main camera 10 when the power cable 12 of the main camera 10 experiences a power loss.

The processor 40 is connected to the main camera 10 and the sub-cameras 20.

The storage unit 50 is connected to the processor 40. The storage unit 50 includes a detecting module 52, a camera selecting module 54, a power switching module 56, and a transmission control module 58.

The detecting module 52 stores a first instruction to be executed by the processor 40, thereby the processor 40 detects working performance of the main camera 10 such as power supply, capturing performance, and transmission performance, then determines whether the camera 10 is malfunctioning. The malfunction to the main camera 10 may be an interruption of power from the power cable 12, interruption of data through the data cable 14, or the lack of light entering the lens of the main camera 10 to the charge couple device (CCD).

The camera selecting module 54 stores a second instruction to be executed by the processor 40, thereby the processor 40 controls the sub-cameras 20 to monitor the location if the main camera 10 is malfunctioning.

The power switching module 56 stores a third instruction to be executed by the processor 40, thereby the processor 40 controls the power units 22 of the sub-cameras 20 to supply power to the main camera 10 when the malfunction to the main camera 10 is the interruption of power from the power cable 12.

The transmission control module 58 stores a fourth instruction to be executed by the processor 40, thereby the processor 40 controls the network units 24 of the sub-cameras 20 to transmit the images captured by the main camera 10 to the display 60 when the malfunction to the main camera 10 is the interruption of data through the data cable 14.

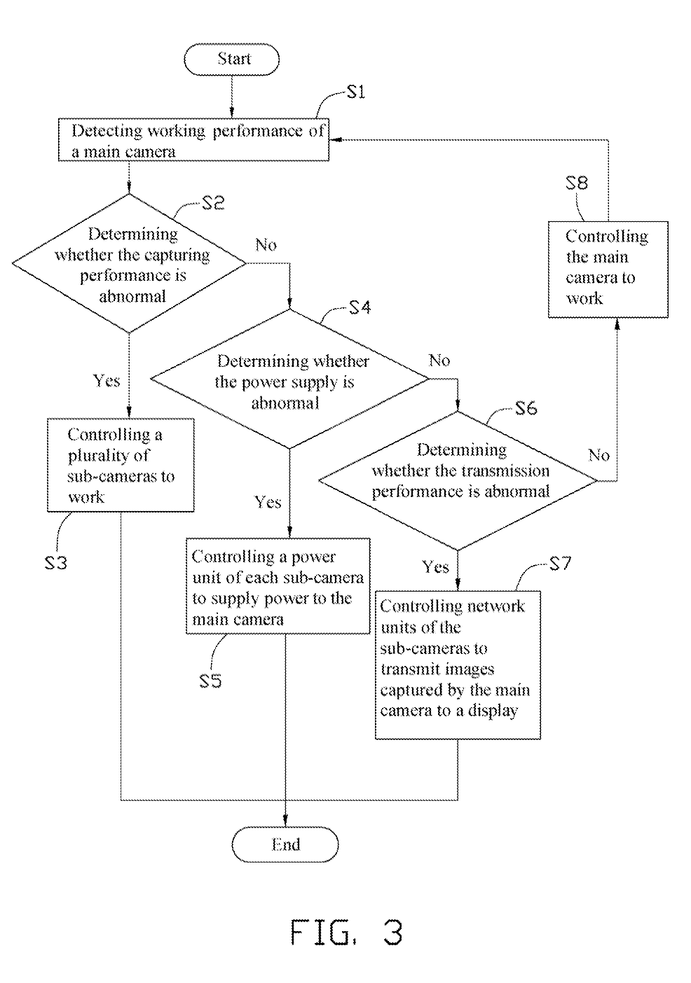

Referring to FIG. 3, an exemplary embodiment of a security monitoring method includes the following steps.

In step S1, the processor 40 detects working performance of the main camera 10, such as power supply, capturing performance, and transmission performance

In step S2, the processor 40 determines whether the main camera 10 is malfunctioning and the capturing performance of the main camera 10 is abnormal. In one embodiment, if the malfunction to the main camera 10 is the lack of light entering the lens of the main camera 10 to the charge couple device (CCD), the processor 40 determines the capturing performance of the main camera 10 is abnormal. If the capturing performance of the main camera 10 is abnormal, the process goes to step 3. If the capturing performance of the main camera 10 is normal, the process goes to step 4.

In step S3, the processor 40 controls the sub-cameras 20 to work, the process ends.

In step S4, the processor 40 determines whether the main camera 10 is malfunctioning and the power supply of the main camera 10 is abnormal. In one embodiment, if the malfunction to the main camera 10 is the interruption of power from the power cable 12, the processor 40 determines the power supply of the main camera 10 is abnormal. If the power supply of the main camera 10 is abnormal, the process goes to step 5. If the power supply of the main camera 10 is normal, the process goes to step 6.

In step S5, the processor 40 controls the sub-cameras 20 to work and controls the power units 22 of the sub-cameras 20 to supply power to the main camera 10, the process ends.

In step S6, the processor 40 determines whether the main camera 10 is malfunctioning and the transmission performance of the main camera 10 is abnormal. In one embodiment, if the malfunction to the main camera 10 is the interruption of data through the data cable 14, the processor 40 determines the transmission performance of the main camera 10 is abnormal. If the transmission performance of the main camera 10 is abnormal, the process goes to step 7. If the transmission performance of the main camera 10 is normal, the process goes to step 8.

In step 7, the processor 40 controls the sub-cameras 20 to work and controls the network units 24 of the sub-cameras 20 to transmit the images captured by the main camera 10 to the display 60, the process ends.

In step 8, the main camera 10 works to monitor the location.

In other embodiments, the order of the step 2, the step 4, and the step 6 can be changed.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A security monitoring system, comprising:
a display displaying images;
a power source;
a main camera connected to the power source though a power cable and connected to the display through a data cable;
a plurality of sub-cameras each comprising a power unit, a network unit, and a capturing unit, wherein the capturing unit captures images, the power unit supplies power to the network unit and the capturing unit, the network unit transmits images captured by the capturing unit to the display;
a processor connected to the main camera and the sub-cameras; and
a storage unit comprising a detecting module and a camera selecting module, wherein the detecting module stores a first instruction to be executed by the processor, thereby the processor determines whether the main camera is malfunctioning, the camera selecting module stores a second instruction to be executed by the processor, thereby the processor controls the plurality of sub-cameras to work if the main camera is malfunctioning.

2. The security monitoring system of claim 1, wherein the plurality of sub-cameras are set on different positions of the main camera.

3. The security monitoring system of claim 1, wherein the plurality of sub-cameras are wireless hidden cameras.

4. The security monitoring system of claim 1, wherein the power unit is a rechargeable battery.

5. The security monitoring system of claim 1, wherein the power source is connected to the power unit of each sub-camera.

6. The security monitoring system of claim 1, wherein the power unit of each sub-camera is connected to the main camera, the storage unit further comprises a power switching module storing a third instruction, the processor executes the third instruction and controls the power units of the plurality of sub-cameras to supply power to the main camera if the malfunction to the main camera is an interruption of power from the power cable.

7. The security monitoring system of claim 1, wherein the main camera is connected to one of the network units, the storage unit further comprises a transmission control module storing a third instruction, the processor executes the third instruction and controls the network unit to transmit the images captured by the main camera to the display if the malfunction to the main camera is an interruption of data through the data cable.

8. A security monitoring method, comprising:
detecting working performance of a main camera;
determining whether the main camera is malfunctioning;
controlling sub-cameras to work if the main camera is malfunctioning; and
controlling the main camera to work if the main camera is not malfunctioning.

9. The security monitoring method of claim 8, wherein if the malfunction to the main camera is an interruption of power from the power cable, a power unit of each sub-camera supplies power to the main camera.

10. The security monitoring method of claim 8, wherein if the malfunction to the main camera is an interruption of data through the data cable, a network unit of a sub-camera transmits images captured by the main camera to a display.
